(19) United States
(12) Patent Application Publication
(10) Pub. No.: US 2024/0413783 A1
(43) Pub. Date: Dec. 12, 2024

(54) A RENEWABLE ENERGY SYSTEM WITH INTEGRATED SOLAR PANELS

(71) Applicant: Amir Tamir MAZIG, Meitar (IL)

(72) Inventor: Amir Tamir MAZIG, Meitar (IL)

(21) Appl. No.: 18/702,393

(22) PCT Filed: Oct. 20, 2022
(86) PCT No.: PCT/IL2022/051111

§ 371 Date: Apr. 18, 2024

(30) Foreign Application Priority Data
Oct. 21, 2021 (IL) 287495

(51) Int. Cl. H02S 20/30; B60H 1/00; B60J 1/18; B60L 1/02; B60L 53/51; H02S 10/20

(52) U.S. Cl. CPC H02S 20/30; B60L 1/02; B60L 53/51; H02S 10/20; B60H 1/00878; B60J 1/18

(57) ABSTRACT

A renewable energy generating system for powering at least one accessory in a vehicle, including: at least one translucent solar panel adapted to be installed as a window pane; and one or more rechargeable batteries adapted to be charged by energy captured by said at least one translucent solar panel, wherein said one or more rechargeable batteries configured to power the one or more accessories.

### FIELD OF THE INVENTION

The invention relates to a renewable energy system, primarily used in vehicles, wherein the said vehicle incorporates a transparent solar panel that either: i) forms an integral part of a window pane, or, ii) is retrofitted onto an existing window pane. The invention further relates to a temperature regulation system which is activated once a temperature threshold is met to ensure that a desired temperature is achieved.

### BACKGROUND OF THE INVENTION

The use of solar panels as integrated components in machines, vehicles, and devices has significantly increased over the last few decades. The ability to incorporate an integrated energy source within one system provides the exciting prospect of developing self-contained and energy-neutral systems that can lower ones carbon footprint; a primary goal in renewable energy initiatives and policy-making.

However, simply adding a renewable energy generating system into pre-existing systems is often cumbersome, presenting significant inefficiencies, which at times cannot justify its installation in the first place. For example, adding a bulky solar panel on top of a vehicle makes the vehicle aerodynamically impaired, causing drag and hence energy loss. The energy generated by such a solar panel may not be able to overcome the energy deficit caused by drag in the first place or at least may not be cost effective, rendering its installation ineffective.

Being able to integrate a renewable energy system without compromising on energy loss is a major challenge in the field of renewable energy applications and a primary goal of the invention detailed herein.

A primary goal of the present invention is to provide a fully integrated solar panel that functions as a window pane primarily in a vehicle. Herein the term “integrate” generally refers to adapting and installing the solar-panel as a replacement for an existing window pane. Accordingly, the general shape of the vehicle and windows remains unaffected and hence the solar-panels are ‘integrated’ into the standard body of the vehicle. This term will be understood by an expert in the art even though variations in the window shape, frame, vehicle body and other may undergo slight changes during installation which in no way detracts from the general scope of the invention nor limit the term ‘integrate’ as used herein.

Another goal of the invention is to create a self-contained renewable energy system wherein a solar panel activates a temperature regulation system e.g., an air conditioning and/or heating system. Additionally, the surplus energy generated from the solar panels is used to recharge an energy storage device, such as a battery, which in turn activates the temperature regulation system when needed.

Another goal of the invention concerns the safety of people within a vehicle. For example, when a vehicle is parked on a hot day the vehicle can heat up to dangerously high temperatures inside. One can understand that “parked” can refer either to a scenario wherein the vehicle's engine is usually switched “off”, or to a scenario wherein the vehicle's engine is switched “on” and the vehicle is stationary. Such high temperatures can lead to fatalities for adults, young children or babies who are trapped (or accidentally left) inside the vehicle. The present invention ensures that the ambient temperature in the vehicle is such that a safe temperature is maintained inside the vehicle at all times, regardless of whether the engine is on or not. Implementing the use of this system alleviates heat related dangers such as dizziness, nausea, dehydration, heat rash, cramps, exhaustion and heat stroke. Conversely, similar arguments can be made regarding dangers relating to extreme cold such as hypothermia and frostbite. Hence, maintaining the temperature within a safe and comfortable range is a primary goal of the present invention, in any adverse climate or weather scenario.

Another goal of the invention is to generally improve the user (or passenger) experience and comfort in a vehicle, in particular for when the user (or passenger) returns to the vehicle after not being present there for a period of time or whilst the vehicle is idling. For example, returning to a vehicle that has heated up on a hot day can be a rather uncomfortable experience and requires some time for the air conditioning to cool the interior of the vehicle to a comfortable level. In addition, the steering wheel and seat (or other) can be so hot that it can affect the drivers' regular driving habits, behaviours and routine thereby increasing the likelihood of an adverse driving event such as a crash. The present invention ensures a safe temperature, for a user returning to a vehicle or a person trapped therein, without the need for the vehicle engine to be on at the time.

Conversely, similar arguments can be made regarding improving the user (or passenger) experience for a person in a vehicle for a cold day. Namely, the self-contained renewable energy system can warm the vehicle up on a cold day, whilst it is parked, to ensure that the vehicle is at a desired and/or comfortable temperature for when the driver returns to the vehicle. In regions that are affected by extreme cold, maintaining an interior vehicle temperature of above 0 degrees Celsius also prevents the vehicle (and windows) from frost, saving the driver time and ultimately protecting the vehicle from damage due to low temperature and wear and tear. In general, maintaining a temperature within a certain range can benefit not only the people present in the vehicle, but the vehicle itself. Heat and cold damage are often causes of wear and tear and/or general deterioration, the present invention alleviates or considerably delays the possibility of such deterioration.

Another object of the present invention is to provide a renewable energy system that is adapted to provide energy for recharging the battery of an electric vehicle (EV) to increase the driving range of the EV's battery.

It is yet another object of the present invention to provide a self-charging solar car.

Other objects and advantages of the invention will become apparent as the description proceeds.

### SUMMARY OF THE INVENTION

A renewable energy generating system for powering at least one accessory in a vehicle, comprising: at least one translucent solar panel adapted to be installed as a window pane; and one or more rechargeable batteries adapted to be charged by energy captured by said at least one translucent solar panel, wherein said one or more rechargeable batteries configured to power the one or more accessories (e.g., when the vehicle is parked).

In one aspect, the at least one translucent solar panel is adapted to be incorporated onto either side of a window pane.

In one aspect, the translucent solar panel has uniform opacity across the window pane. In another aspect, the solar panel has non-uniform opacity across the window pane.

In one aspect, the translucent solar panel is installed in more than one window location on the vehicle.

In one aspect, the at least one accessory is a temperature regulation system that comprises at least one air conditioning and/or heating unit.

In one aspect, the energy supply for the temperature regulation system is directly from the solar panel alone. In another aspect, the energy supply for the temperature regulation system is from the rechargeable batteries alone.

In one aspect, the energy supply for the temperature regulation system is additionally from the one or more rechargeable batteries.

In one aspect, the accessory is an on-vehicle electric vehicle (EV) charging station adapted for recharging a battery of the EV to increase the driving range of the EV's battery.

In yet another aspect, the invention relates to a method of temperature regulation in a vehicle using the renewable energy system, comprising the following steps:
setting the desired upper and lower limits of a temperature threshold;
continuously acquiring temperature data; and
processing said data in a processing unit, wherein the heating and cooling units are activated, to maintain the temperature within the upper and lower limits of the temperature threshold.

In one aspect, the method further comprises recharging one or more rechargeable batteries when there is a surplus of energy generated by the solar panels.

### BRIEF DESCRIPTION OF THE DRAWINGS

In the drawings:

FIG. 1a—A schematic of a translucent solar panel window pane;

FIG. 1b—A schematic of a window pane wherein only the top part incorporates a translucent solar panel;

FIG. 1c—A schematic of a window pane wherein the translucence of the solar panel varies across the window pane;

FIG. 1d—A schematic of a window pane wherein the solar panel is patterned on the window pane;

FIG. 2—A schematic of a car with two windows that incorporate a translucent solar panel but with different opacities;

FIG. 3a—A schematic cross-section of a window frame and pane with a retrofitted translucent solar panel;

FIG. 3b—A schematic cross-section of a window frame and pane with retrofitted solar panel that has a transparency gradient across it;

FIG. 4—A schematic diagram of the renewable energy system.

### DETAILED DESCRIPTION OF THE INVENTION

The present invention relates to a renewable energy generating system comprising a translucent solar panel adapted to be installed as a window pane, primarily for use in vehicles. Herein, the term translucent refers to any material that at least partly allows light to pass through it. This is in contradistinction to something which is opaque (does not let light pass through) or transparent (allows light through almost completely). Furthermore, an expert in the art will be fully aware that there are numerous synonymous terms referring to the passage of light through materials. For example, an expert understands that terms such as translucent, non- and semi-transparent and partly opaque can be used interchangeably without limiting the scope of the invention. Accordingly, these terms will be used herein.

A primary goal of the invention is to avoid using external solar panel units that would compromise the vehicle's aerodynamic profile. Otherwise, external solar panel units cause unwanted drag which would require additional fuel consumption to compensate for its presence.

In one embodiment the invention utilizes a fully integrate window pane that is itself the solar panel.

The solar panels referred to herein refer generally to photovoltaic (PV) cells, or combinations thereof, wherein light is converted into electrical energy using semiconducting materials. A PV system generally requires a solar panel, an inverter to convert electrical signals from direct current (D.C.) to alternating current (A.C) (or vice versa) and other standard electrical components.

Since the absorption spectrum of most PV cells include the visible spectrum window (˜400-700 nm wavelength), it is rare to find a PV cell that is fully transparent. Nonetheless, a plethora of semi-transparent solar panels are currently available on the market. The invention is not limited to the type of solar cell that is used e.g., it can be organic-based, silicon-based, tandem based, hybrid, thin film, etc.

Reference will now be made to several embodiments of the solar panels of the present invention, examples of which are illustrated in the accompanying figures. Wherever practicable, similar or identical reference numbers may be used in the figures and may indicate similar or identical functionality. The figures depict embodiments of the present invention for purposes of illustration only. One skilled in the art will readily recognize from the following description that alternative embodiments of the structures illustrated herein may be employed without departing from the principles of the invention described herein.

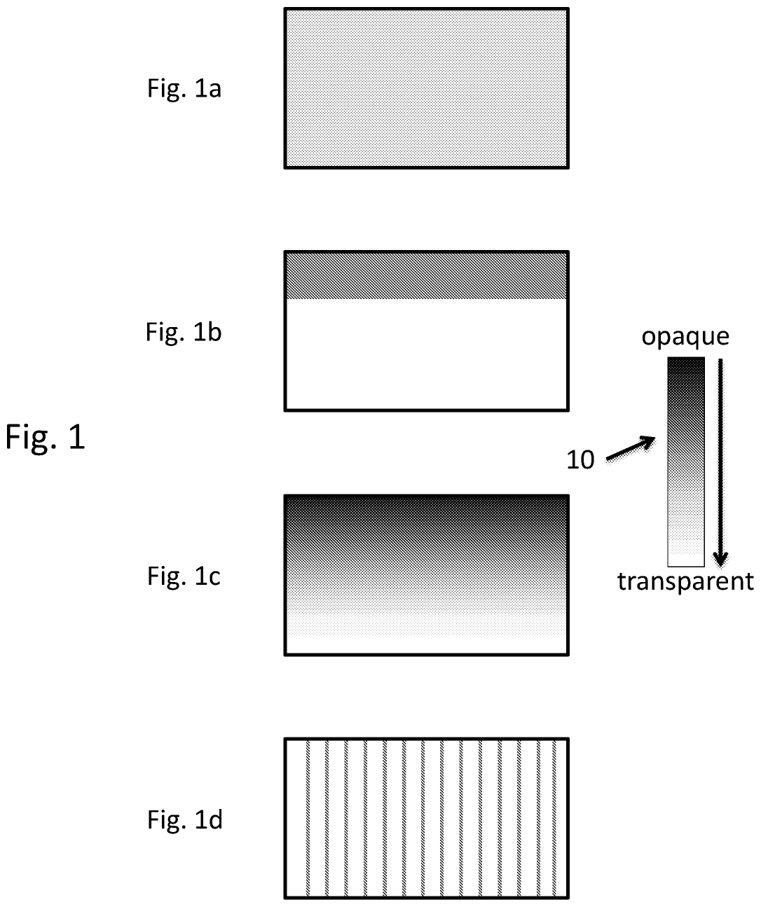

In one embodiment the translucent solar panel is of uniform translucence across the whole window pane, as shown in FIG. 1a. The translucence of the solar panels can be selected according to the desire of the user and/or owner of the vehicle prior to installation. A schematic scale/legend 10 in FIG. 1 shows the range of opacity for such a solar panel; from completely opaque (black) to fully transparent (white). Accordingly, the solar panel acts as an integrated window pane and is adapted to and/or can be installed on any vehicle. The phrase “adapted to” as used herein and the accompanying claims, imposes no additional structural limitations but generally refers to maintaining the vehicle's original shape and form. Furthermore, the shape of the solar panel is not limited and can thus be adapted for use in any vehicle window of any shape and/or vehicle model.

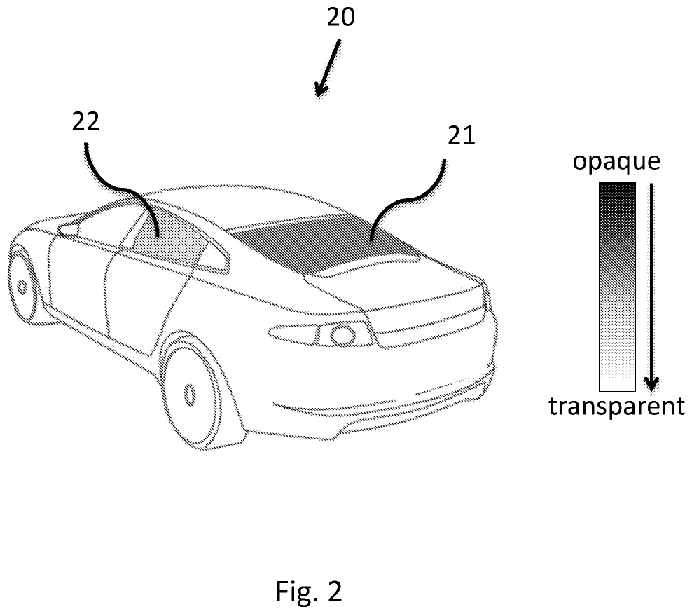

In one embodiment, shown in FIG. 2, a schematic car 20 has one integrated solar-panel window pane 21 which is more opaque than the other window pane 22. Any number of variations can exist when selecting the opacity and type of solar panels in a vehicle.

In general the opacity of the solar panel relates to its efficiency in converting light into electrical energy. Herein “efficiency” generally refers to the ability of the solar panel to covert light into electrical energy and is normally represented as a percentage or fraction i.e., a 100% efficient solar panel converts the entire light incident thereon into electrical energy.

There are generally two competing interests when considering the opacity of the solar panel: 1) the energy conversion efficiency of light into electrical energy, 2) the visibility (i.e., the window's transparency). For example, a darker window may have a higher solar energy conversion efficiency, however, it will have poorer visibility. Whereas an almost transparent window will have good visibility but may have poor solar energy conversion efficiency. As such, the opacity of the integrated solar panel needs to be selected according to the needs of the driver/user/owner of the vehicle. It is obvious to any driver that the necessity of good visibility varies from window to window and depends on its location on the vehicle. For example, the rear-view or side-windows generally require less visibility than the front windscreen.

Therefore, in one embodiment of the invention, the opacity of the integrated solar-panel windows can be selected according to the desired and/or required visibility of the driver. Furthermore, it should be noted that standard window-tinting practice is subject to legal restrictions and variability in different regions. Understandably, front windscreens generally require higher visibility than other windows in the vehicle. Generally, about 70-80% of light must pass through a front windscreen. However, there is often no restriction to the opacity of the rear-view window. Thus, in one embodiment, the rear-view window can constitute a fully opaque integrated solar panel.

To maximize the solar energy capacity of the renewable energy system it is often desirable to increase the surface area coverage of the solar panels as much as possible. Therefore, although there may be restrictions in the general opacity of the front windscreen (and/or side windows), in another embodiment of the invention the window pane as a whole can be split into more than one section e.g., a fully transparent section and a semi-transparent one that incorporates the solar panel, all on the same window pane as shown in FIG. 1b. In many global locations, where sunshine is intense and can cause a hindrance to a driver's visibility, a solar-shaded strip is located at the top of the windscreen. The embodiment of FIG. 1b shows that a semi-transparent solar panel can be placed instead of such a solar-shade strip and be incorporated into the window pane itself, at the desired location, all without compromising the driver's visibility.

In another embodiment, shown in FIG. 1c, the integrated solar-panel window pane is adapted to form a gradient of transparency from fully opaque to fully transparent, from the top to the bottom of the window pane. It is understood by an expert in the art that any opacity gradient range can be utilized in this embodiment according to the user's desires, needs and requirements.

In another embodiment, the solar-panel window pane is patterned with vertical lines, as shown in FIG. 1d. The patterning of these solar panels as vertical strips is merely an example of patterning in general. It is noted that certain patterns and/or shapes are more cost-effective and efficacious regarding their solar efficiency, production, manufacturing and installation. Such patterns can include, but is not limited to: vertical/horizontal/diagonal lines, net/mesh/crisscross patterns and sinusoidal patterns. An advantage of patterning is that some solar cell materials are considerably opaque. Patterning opaque materials in a window pane allows for general visibility through a window pane, since some parts of the window pane are not patterned, whilst also providing PV capabilities. Patterning therefore allows for flexibility in terms of the requirements regarding visibility and energy conversion efficiency.

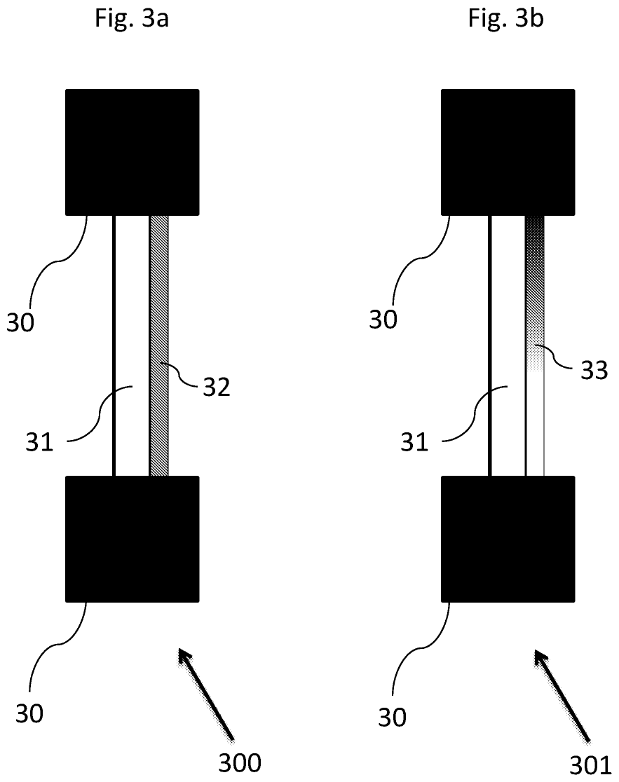

In another embodiment of the invention the solar panel is retrofitted onto pre-existing window panes. The terms “retrofit” and “retrofitting” general refer to an act of adding a component or accessory to something that did not have it when manufactured; in this case, adding a solar panel to an existing window pane. FIG. 3a displays a cross-section of a window frame 300 wherein the body of the vehicle 30 and the glass window pane 31 are coated on one side with a translucent solar panel 32. In the embodiment shown in FIG. 3a the solar panel can be placed on either or both sides of the window pane 31 by any means of adhesion. Examples of such adhesion include but is not limited to: glue, epoxy, electrostatic attraction, thin-film attraction and pressure-sensitive adhesives. In two embodiments of the invention, FIGS. 3a and 3b show cross-sections of a window frame (300 and 301, respectively) wherein the solar panel has a uniform translucence 32 or a translucence gradient 33, respectively.

Retrofitting solar panels in this manner provides an advantage wherein installation costs can be considerably reduced. In one embodiment, the solar panels are thin enough so that windows can be opened and closed in the regular manner. Nonetheless, the rear-view window and front windscreen have no such limitation and, in one embodiment, these retrofitted solar panels can afford to be thicker.

In another embodiment, the retrofitted solar panels are flexible. As such, long rolls of this solar panel can be manufactured, for easier production, transport, distribution and fitting; as well as potentially lowering the cost of the solar panels themselves.

In another embodiment, one or more windows in a single vehicle can have the integrated translucent solar panel whilst at the same time one or more other windows can have the retrofitted solar panels.

Reference will now be made to several embodiments of the temperature regulation system of the present invention, examples of which are illustrated in the accompanying figures.

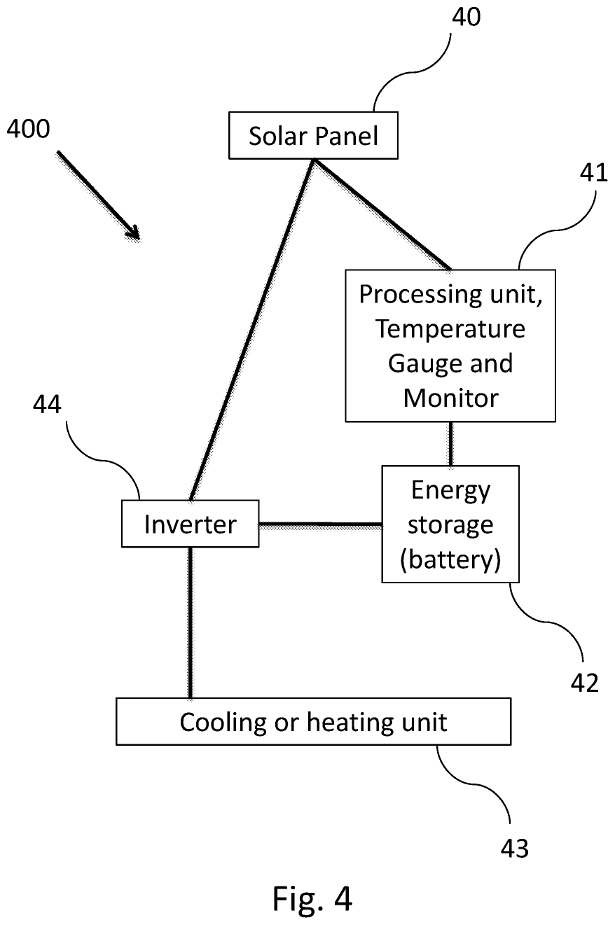

FIG. 4 displays a renewable energy temperature regulation system 400. The solar panel 40 is connected to one or more temperature gauges and/or monitors 41, which continuously supply the processing unit 41 with data. Temperature gauges and monitors are standard electrical components that can be distributed throughout the vehicle to calculate temperatures and even locate temperature gradients throughout the vehicle.

In one embodiment, these said temperature gauges, monitors and processing units 41 are hardwired to the system via standard electrical cables and/or wiring.

In another embodiment, these said temperature gauges, monitors and processing units operate remotely e.g., via Bluetooth, internet servers, the cloud, etc.

In another embodiment the processing unit can be a separate unit installed in the vehicle itself or otherwise it can be located remotely, such as on a personal electronic device e.g., a smartphone, laptop, tablet, smartwatches, etc. Furthermore, both an internal and remote processing unit can operate in conjunction with one another through standard syncing practices and share processing, analysis functions, user settings, troubleshooting, data sharing and the like. As such, processing units routinely use cloud-based tools, big data mining, artificial intelligence, the internet, deep learning and other elements which can all be incorporated into the present invention without limiting its scope.

In one embodiment, the invention can be used in conjunction with motion-detecting cameras in a vehicle. For example, if no person is present in a certain carriage on a train, the camera can relay this data to the processing unit which can activate the temperature regulation systems accordingly e.g., with less urgency, whereas, if the camera detects many bodies inside the train (or can predict that many more passengers will board the train) then the temperature regulation system can be primed and activated accordingly.

The upper and lower limits of a temperature threshold are set by the user at the outset. This information is stored and used by the processing unit 41 and also in conjunction with the user's personal electronic device which can remotely operate, display and manipulate data acquired by the processing unit. The user selects a maximum and minimum temperature threshold beyond which the air conditioning or heating units 43 are activated, respectively. Typically, there is more than one air conditioning and/or heating outlet inside the vehicle. As such, more than one of said air conditioning and/or heating outlets can operate at any one time. For example, if there is a temperature gradient across the vehicle, the air conditioning and/or heating outlet can be activated to ensure a uniform temperature gradient within the vehicle.

Whilst continuously gathering data related to the temperature within the vehicle, the processing unit 41 determines whether a temperature threshold has been surpassed. If the temperature threshold has not been surpassed, i.e., the temperature has either gone above the maximum temperature or below the minimum temperature, the energy from the solar panel unit 40 is directed towards charging the energy storage device 42 e.g., a battery. However, if the temperature threshold is surpassed, the energy from the solar panel 40 and/or the battery 42 is directed towards activating the cooling and/or heating unit 43.

In one embodiment of the invention, a delivery vehicle needs to maintain a certain temperature within the vehicle and will utilize the temperature regulation system to achieve the desirable temperature. Furthermore, a delivery truck is divided into multiple compartments: 1) the compartment where the driver sits (generally at the front of the truck) and, 2) the compartment where the goods are being stored for transportation. In another embodiment of the temperature regulation system, and for example purposes alone, one compartment can be cooled whilst the other heated, or vice versa. This allows for versatility in the temperature regulation system whereby the system can both cool and heat simultaneously, all according to the needs of the driver and/or scenario.

In a further embodiment, a bus and/or train, may contain multiple compartments e.g., different carriages or floors/levels. As such, the temperature regulation system can activate cooling and/or heating systems simultaneously according to the needs of the user, passengers, operators and/or scenario. For example, if one compartment in a train is not in use, the temperature regulation system will either not be activates in that carriage, or at least operate on a minimum capacity and not be prioritized by the system. The processing unit 41 can calculate such scenarios to prioritize the activation of the temperature regulation system in different scenarios.

In another embodiment, the renewable energy system is adapted to provide energy to any additional device, component and/or accessory inside the vehicle such as a phone recharging unit or a refrigerator. As will be appreciated by a person skilled in the art the renewable energy system of this invention can be integrated with any electrical component, device and/or accessory that is already present in the vehicle itself without compromising the scope the invention. Further examples of such devices, components and/or accessories that the renewable energy system can be adapted for includes, but is not limited to, the vehicle headlights, radio, lighting, etc. The terms ‘device’, ‘component’ and ‘accessory’, as used herein, are used interchangeably and are not intended to limit the scope of the present invention but generally refers to connecting the renewable energy system electrically to said device, component and/or accessory.

In another embodiment, the renewable energy system is adapted to provide energy towards recharging the vehicle's main battery (also generally referred to as an ‘automotive battery’), which is typically recharged via an alternator. This can be carried out whether the vehicle is moving or stationary. According to some embodiments of the invention, the renewable energy system is adapted to provide energy for recharging the battery of an electric vehicle (EV) to increase the driving range of the EV's battery. For example, in such cases, the accessory is an on-vehicle EV charging station powered by the renewable energy system. According to an embodiment of the invention, the renewable energy system harnesses the sun's power to provide a self-charging solar car.

Examples are presented below whereby the cooling or heating units 43 are activated. These examples in no way serve to limit the scope of the present invention. Indeed, an expert in the art will understand the many permutations and applications of the present invention that can be inferred herein. For example, the heating and cooling systems 43 can be activated in some of the following ways:
1) Energy from the solar panel 40 alone is directed towards the cooling or heating unit 43 via an inverter 44. The processing unit 41 can determine whether this is the most effective strategy, such as when the battery is not charged, or when the temperature is only marginally beyond the threshold i.e., not requiring such high energy input. In this embodiment, the processing unit bypasses the battery 42, which remains inactive;
2) Energy from the solar panel 40, in addition to the energy storage unit 42, is directed towards the cooling or heating unit 43 via the inverter. The processing unit 41, can calculate when to use a combination of the two energy sources (versus just one energy source) such as when the vehicle is experiencing extreme hot or cold, requiring more energy input to return the temperature to within the desired temperature range;
3) Energy from the battery 42 alone is directed towards the cooling or heating unit 43 via an inverter 44. This strategy can be implemented via the processing unit 41 in a situation where (for example) there is extensive cloud coverage and the solar panels do not generate enough energy to assist in returning the temperature to within the desirable temperature range;

In another embodiment of the present invention the solar panels can be used to regulate the temperature within a stationary structure. Such an embodiment can work in conjunction with an extent temperature regulation system to reduce the overall cost of electricity.

1-16. (canceled)

17. A renewable energy generating system for powering at least one accessory in a vehicle, comprising:
at least one translucent solar panel adapted to be installed as a window pane, wherein said translucent solar panel has uniform or non-uniform opacity across the window pane; and
one or more rechargeable batteries adapted to be charged by energy captured by said at least one translucent solar panel, wherein said one or more rechargeable batteries is configured to power the one or more accessories within said vehicle.

18. A renewable energy generating system according to claim 17, wherein the at least one of the one or more rechargeable batteries is configured to power the one or more accessories when the vehicle is parked.

19. A renewable energy generating system according to claim 17, wherein the at least one translucent solar panel is adapted to be incorporated onto either side of a window pane.

20. The renewable energy generating system of claim 17, wherein the translucent solar panel has uniform opacity across the window pane.

21. The renewable energy generating system of claim 17, wherein the solar panel has non-uniform opacity across the window pane.

22. The renewable energy generating system of claim 17, wherein the translucent solar panel is installed in more than one location on the vehicle.

23. The renewable energy generating system of claim 17, wherein the at least one accessory is a temperature regulation system that comprises at least one air conditioning and/or heating unit.

24. The renewable energy generating system of claim 23, wherein the energy supply for the temperature regulation system is directly from the solar panel alone.

25. The renewable energy generating system of claim 23, wherein the energy supply for the temperature regulation system is from the rechargeable batteries alone.

26. The renewable energy generating system of claim 25, wherein the energy supply for the temperature regulation system is additionally from the one or more rechargeable batteries.

27. The renewable energy system according to claim 17, the accessory is an on-vehicle electric vehicle (EV) charging station adapted for recharging a battery of the EV to increase the driving range of the EV's battery.

28. A method of temperature regulation in a vehicle using the renewable energy system of claim 1, comprising the following steps:
setting the desired upper and lower limits of a temperature threshold;
continuously acquiring temperature data; and
processing said data in a processing unit, wherein the heating and cooling units are activated, to maintain the temperature within the upper and lower limits of the temperature threshold.

29. The method of claim 28, further comprising recharging one or more rechargeable batteries when there is a surplus of energy generated by the solar panels.
